(19) United States
(12) Patent Application Publication
(10) Pub. No.: US 2015/0246650 A1
(43) Pub. Date: Sep. 3, 2015

(54) IN-VEHICLE ELECTRICAL EQUIPMENT SPARE BATTERY UNIT, POWER SUPPLY DEVICE FOR VEHICLE, AND VEHICLE EQUIPPED WITH POWER SUPPLY DEVICE

(71) Applicant: SANYO ELECTRIC CO., LTD., Moriguchi-shi, Osaka (JP)

(72) Inventors: Kaoru Nakajima, Hyogo (JP); Akinobu Tsunesada, Hyogo (JP); Hideki Sakata, Hyogo (JP); Nobuyuki Ohsumi, Hyogo (JP)

(21) Appl. No.: 14/429,357

(22) PCT Filed: Oct. 17, 2013
(86) PCT No.: PCT/JP2013/006166

§ 371 Date: Mar. 18, 2015

(30) Foreign Application Priority Data
Oct. 29, 2012 (JP) 2012-238116

(51) Int. Cl. B60R 16/04; B60R 16/033; B60R 16/02

(52) U.S. Cl. CPC B60R 16/04; B60R 16/0207; B60R 16/033

(57) ABSTRACT

A vehicle electrical equipment auxiliary battery unit to being capable of being connected in parallel to an electrical equipment battery installed in a vehicle, comprises a sub-battery which stores plural battery cells in a housing case, a fixing mechanism which fixes the housing case of the sub-battery in a vehicle cabin, a harness which is inserted through a pull-out hole that penetrates an inner wall of the vehicle cabin, and connects the sub-battery to the electrical equipment battery positioned outside the vehicle cabin in parallel, and a gas pipe which is coupled to the housing case, and exhausts a gas exhausted from the battery cells outside the vehicle cabin, and the gas pipe is inserted through the pull-out hole, through which the harness is inserted, and is led outside the vehicle cabin.

### TECHNICAL FIELD

The present invention is related to an in-vehicle electrical equipment spare battery unit which is connected in parallel to an electrical equipment battery that supplies power to a vehicle electric load installed in the vehicle, a power supply device for vehicle having this in-vehicle electrical equipment spare battery unit, and a vehicle equipped with this power supply device.

### BACKGROUND ART

A conventional vehicles installs a lead battery using a lead storage batter of a rated voltage 12 V as an electrical equipment battery. Further, in a large vehicle, two of the 12 V lead batteries are connected in series, and then the battery of the rated voltage 24 V is installed. The lead battery is charged by the alternator of the vehicle, and supplies power to a vehicle electric load of an electric equipment of the vehicle or a starter motor. As this lead battery has a low discharging resistance, but has a large charging resistance, there is a demerit that it is difficult to efficiently charge. In order to improve this demerit and enlarge a battery capacity (Ah) per volume or per weight, a vehicle power supply device in which the lead battery is connected in parallel to a sub-battery of a nickel hydride battery or a lithium ion secondary battery, has been developed (refer to patent literature 1).

When such a sub-battery is disposed in an engine room in the same way as the normal lead battery, it is exposed in an environment of a remarkably high temperature. Especially, in the case that the nickel hydride battery or the lithium ion secondary battery is used as the sub-battery, a battery performance is degraded. Then, it is proposed that the sub-battery is disposed in the cabin (passenger compartment) of the vehicle (for example, refer to patent literature 2).

### CITATION LIST

### Patent Literature

Patent Literature 1: Japanese Laid-Open Patent Publication No. 2007-46508

Patent Literature 1: Japanese Laid-Open Patent Publication No. 2008-74159

### SUMMARY OF THE INVENTION

On the other hand, in the case that the nickel hydride battery or the lithium ion secondary battery is used as the sub-battery,

It happens that a gas is exhausted when the inner pressure is increased at the high temperature of the battery cell. In this case, in order to prevent the gas exhausted from the battery cell from filling the cabin, it is necessary that a gas duct is prepared and set to exhaust the gas outside the cabin. It increases a cost that a hole is opened at an inner wall of the cabin to set the gas duct.

The present disclosure is developed for the purpose of solving such drawbacks. One non-limiting and explanatory embodiment provides a vehicle electrical equipment auxiliary battery, a vehicle power supply device, and a vehicle incorporating the vehicle power supply device which facilitates making a structure or pipework that a gas exhausted from batter cells of a sub-battery disposed in a cabin, is exhausted outside the cabin.

In the present disclosure, a vehicle electrical equipment auxiliary battery unit to being capable of being connected in parallel to an electrical equipment battery 1 installed in a vehicle, comprises a sub-battery 2 which stores plural battery cells 4 in a housing case 3, a fixing mechanism 5 which fixes the housing case 3 of the sub-battery 2 in a vehicle cabin 12, a harness 6 which is inserted through a pull-out hole 16 that penetrates an inner wall 14 of the vehicle cabin 12, and connects the sub-battery 2 to the electrical equipment battery 1 positioned outside the vehicle cabin 12 in parallel, and a gas pipe 8 which is coupled to the housing case 3, and exhausts a gas exhausted from the battery cells 4 outside the vehicle cabin 12, and the gas pipe 8 is inserted through the pull-out hole 16, through which the harness 6 is inserted, and is led outside the vehicle cabin 12. Accordingly, it is not necessary to open a new through hole at the inner wall of the vehicle cabin for the gas pipe, and the pull-out hole for the harness also is used as the pull-out hole for the gas pipe, and it can reduce a manufacturing cost and simplify a piping work. Especially, as the harness and the gas pipe are simultaneously piped, while a work is efficiently carried out, the gas from the battery cells of the sub-battery disposed in the vehicle cabin can be surely exhausted outside the vehicle cabin.

Moreover, in the present disclosure, a vehicle electrical equipment auxiliary battery unit to being capable of being connected in parallel to an electrical equipment battery 1 installed in a vehicle, comprises a sub-battery 2 which stores plural battery cells 4 in a housing case 3, a fixing mechanism 5 which fixes the housing case 3 of the sub-battery 2 to a floor face 14A in a vehicle cabin 12, and a gas exhaust portion 9 which exhausts a gas exhausted from the battery cells 4 outside the housing case 3, and the gas exhaust portion 9 exhausts the gas exhausted from the housing case 3 through a through hole 17 opened at the floor face 14A of the vehicle cabin 12 outside the vehicle cabin 12.

Accordingly, it is not necessary to pipe a separate pipe for exhausting the gas generated from the battery cells of the sub-battery, and while reducing a manufacturing cost, the gas from the battery cells of the sub-battery disposed in the vehicle cabin can be surely exhausted outside the vehicle cabin.

Moreover, in the present disclosure, in the vehicle electrical equipment auxiliary battery unit, the gas exhaust portion 9 is a coupling hole 32 opened at a bottom side facing surface 3B of the housing case 3, and the coupling hole 32 is coupled to the through hole 17 opened at the floor face 14A of the vehicle cabin 12.

Accordingly, the gas filling the housing case from the battery cells of the sub-battery can be exhausted outside the vehicle cabin by the simple structure.

Moreover, in the present disclosure, in the vehicle electrical equipment auxiliary battery unit, the gas exhaust portion 9 is a gas exhaust tube portion 33, 34 which penetrates the through hole 17 opened at the floor face 14A of the vehicle cabin 12, and connects an inside of the housing case 3 and an outside of the vehicle cabin 12 with consecutive space.

Accordingly, the gas exhausted from the housing case is surely exhausted outside the vehicle cabin without the gas leak. Especially, under the condition where the vehicle receives vertical vibration by driving, an inside of the housing case and an outside of the vehicle cabin are surely coupled to each other with consecutive space by the gas exhaust tube portion.

Moreover, in the present disclosure, in the vehicle electrical equipment auxiliary battery unit, the gas exhaust portion 9 has an exhaust valve 40, and the exhaust valve 40 makes the gas pass toward outside of the vehicle cabin 12, but does not make the gas pass toward the inside of the housing case 3 from the outside of the vehicle cabin 12.

Accordingly, while the gas exhausted from the battery cells passes through the gas exhaust portion and is smoothly exhausted outside the vehicle cabin, it surely prevents the gas exhausted outside the vehicle cabin from flowing backward into the housing case, and then it effectively prevents the foreign object or the moisture of the outside from flowing into the housing case.

Moreover, in the present disclosure, in the vehicle electrical equipment auxiliary battery unit, the battery cells 4 are nickel hydride batteries.

Accordingly, it has an excellent property for power storage in an environment of a high temperature, the gas exhausted from the nickel hydride batteries is safely exhausted, and it is stably used.

In the present disclosure, a vehicle power supply device comprises an electrical equipment battery 1 which is disposed outside a vehicle cabin 12, and is installed in a vehicle, and supplies power to a vehicle electric load 61 installed in the vehicle, a sub-battery 1 which is disposed inside the vehicle cabin 12, and stores plural battery cells 4 in a housing case 3, a harness 6 which is inserted through a pull-out hole 16 that penetrates an inner wall 14 of the vehicle cabin 12, and connects the electrical equipment battery 1 to the sub-battery 2 in parallel, and a gas pipe 8 which is coupled to the housing case 3, and exhausts a gas exhausted from the battery cells 4 outside the vehicle cabin 12, and the gas pipe 8 is inserted through the pull-out hole 16, through which the harness 6 is inserted, and is led outside the vehicle cabin 12.

Accordingly, it is not necessary to open a through hole for exclusive use at the inner wall of the vehicle cabin for the gas pipe, and the pull-out hole for the harness also is used as the pull-out hole for the gas pipe, and it can simplify a piping work and then the gas from the battery cells of the sub-battery disposed in the vehicle cabin can be surely exhausted outside the vehicle cabin.

In the present disclosure, a vehicle power supply device comprises an electrical equipment battery 1 which is disposed outside a vehicle cabin 12, and is installed in a vehicle, and supplies power to a vehicle electric load 61 installed in the vehicle, a sub-battery 2 which is disposed inside the vehicle cabin 12, and stores plural battery cells 4 in a housing case 3, and a gas exhaust portion 9 which exhausts a gas exhausted from the battery cells 4 outside the housing case 3, and the gas exhaust portion 9 exhausts the gas exhausted from the housing case 3 through a through hole 17 opened at a floor face 14A of the vehicle cabin 12 outside the vehicle cabin 12.

Accordingly, it is not necessary to pipe a separate pipe for exhausting the gas generated from the battery cells of the sub-battery, and while reducing a manufacturing cost, the gas from the battery cells of the sub-battery disposed in the vehicle cabin can be surely exhausted outside the vehicle cabin.

In the present disclosure, a vehicle incorporating a vehicle power supply device comprises an electrical equipment battery 1 which supplies power to a vehicle electric load 61, and a sub-battery 2 which is connected in parallel to the electrical equipment battery 1, the sub-battery 2 is disposed inside a vehicle cabin 12, and stores plural battery cells 4 in a housing case 3, and the electrical equipment battery 1 is disposed outside the vehicle cabin 12, and the sub-battery 2 and the electrical equipment battery 1 are connected in parallel through a harness 6 which is inserted through a pull-out hole 16 that penetrates an inner wall 14 of the vehicle cabin 12, and it further comprises a gas pipe 8 which exhausts a gas exhausted from the battery cells 4 of the sub-battery 2 outside the vehicle cabin 12, and the gas pipe 8 is inserted through the pull-out hole 16, through which the harness 6 is inserted, and is led outside the vehicle cabin 12.

In the present disclosure, a vehicle incorporating a vehicle power supply device comprises an electrical equipment battery 1 which supplies power to a vehicle electric load 61, and a sub-battery 2 which is connected in parallel to the electrical equipment battery 1, and the sub-battery 2 is disposed inside a vehicle cabin 12, and stores plural battery cells 4 in a housing case 3, and the electrical equipment battery 1 is disposed outside the vehicle cabin 12, the housing case 3 is fixed to a floor face 14A in a vehicle cabin 12, and has a gas exhaust portion 9 which exhausts a gas exhausted from the battery cells 4 outside the housing case 3, and the gas exhaust portion 9 is coupled to a through hole 17 opened at the floor face 14A, and connects an inside of the housing case 3 and an outside of the vehicle cabin 12 with consecutive space.

### BRIEF DESCRIPTION OF DRAWINGS

FIG. 1 is a schematic view of a vehicle incorporating a vehicle power supply device of one embodiment in the present invention.

FIG. 2 is a block diagram of the vehicle incorporating the vehicle power supply device of the one embodiment in the present invention.

FIG. 3 is a sectional view showing a state where a sub-battery is set underneath a seat.

FIG. 4 is a perspective view showing one example of a sub-battery.

FIG. 5 is a sectional view of a gas exhaust portion of a sub-battery of another embodiment in the present invention.

FIG. 6 is a sectional view of a gas exhaust portion of a sub-battery of another embodiment in the present invention.

FIG. 7 is a sectional view of a gas exhaust portion of a sub-battery of another embodiment in the present invention.

### DESCRIPTION OF EMBODIMENTS

Hereinafter, the embodiment of the present invention will be described referring to drawings. However, the following embodiments illustrate a vehicle electrical equipment auxiliary battery, a vehicle power supply device, and a vehicle incorporating the vehicle power supply device which are aimed at embodying the technological concept of the present invention, and the present invention is not limited to the vehicle electrical equipment auxiliary battery, the vehicle power supply device, and the vehicle incorporating the vehicle power supply device described below. In particular, as long as specific descriptions are not provided, it is not intended that the claims be limited to sizes, materials, shapes, and relative arrangements of constitutional members described in the embodiments, which are mere descriptive examples. It is noted that the magnitude or positional relation of the members illustrated in each diagram is sometimes grandiloquently represented, in order to clarify the description. Furthermore, in the description below, identical names and reference numbers represent identical or homogeneous members, and detailed descriptions are appropriately omitted. Moreover, mode may be applied where each element constituting the present invention constitutes a plurality of elements with the use of the same member, thereby serving the plurality of elements with the use of one member, or, in contrast, mode may be realized where a function of the one member is shared by a plurality of members. Also, a portion of examples and the content described in the embodiments can be applied to other examples and another embodiment.

### Embodiment 1

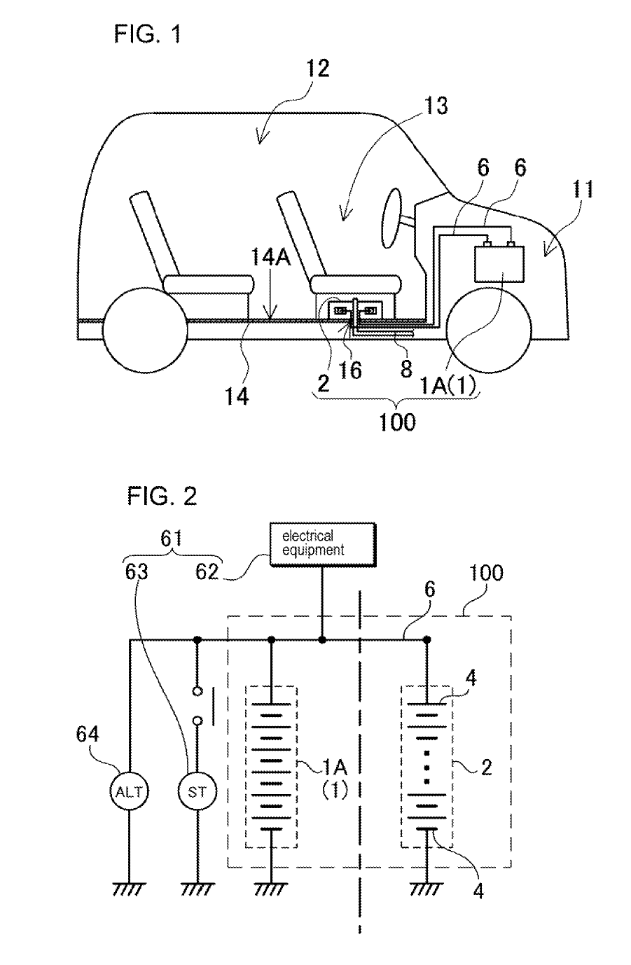

The power supply device 100 related to an embodiment 1 of the present embodiment is shown in FIG. 1 and FIG. 2. FIG. 1 shows a schematic view of a vehicle incorporating the power supply device 100 of one embodiment in the present invention. FIG. 2 shows a block diagram of the vehicle. The power supply device 100 shown in these figures has an electrical equipment battery 1 which is supplies power to a vehicle electric load 61 installed in the vehicle, a sub-battery 2 which is connected in parallel to this electrical equipment battery 1, a harness 6 which connects the electrical equipment battery 1 to the sub-battery 2 in parallel. The electrical equipment battery 1 is disposed outside a vehicle cabin 12, and a sub-battery 2 is disposed inside the vehicle cabin 12. Additionally, the power supply device 100 has a gas pipe 8 which exhausts a gas exhausted from battery cells 4 outside the vehicle cabin 12.

The electrical equipment battery 1 and the sub-battery 2 are respectively disposed at predetermined locations outside and inside the vehicle cabin 12. In the vehicle shown in FIG. 1, the electrical equipment battery 1 is disposed in an engine room 11, and the sub-battery 2 is disposed underneath a seat 13. The present embodiment has a feature of a structure in which the gas exhausted from the battery cells 4 incorporated in the sub-battery 2 inside the vehicle cabin 12 is exhausted outside the vehicle cabin 12. Therefore, a setting location of the electrical equipment battery 1 disposed outside the vehicle cabin 12, or a setting location of the sub-battery 2 disposed inside the vehicle cabin 12 is not limited to a specific one. Preferably, the electrical equipment battery 1 disposed outside the vehicle cabin 12 is disposed in the engine room 11 of the vehicle as shown in FIG. 1. Here, the electrical equipment battery 1 is not necessarily need to be disposed in the engine room 11, it is possible that it is disposed at other locations outside the vehicle cabin, for example, in a trunk room, or underneath a bed of a truck.

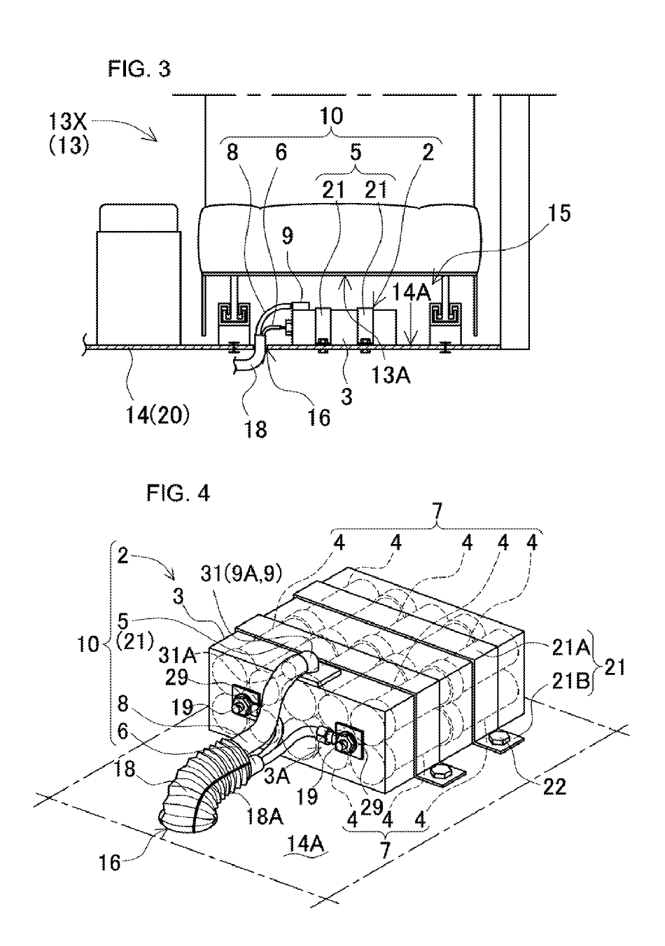

Preferably, the sub-battery 2 disposed inside the vehicle cabin is disposed underneath the seat 13. In the structure where the sub-battery 2 is disposed underneath the seat 13, while a dead space made underneath the seat 13 is used effectively, the sub-battery 2 can be disposed in the vehicle cabin 12. Here, the sub-battery 2 can be disposed at other locations inside the vehicle cabin 12, for example, a space between a driver's seat and a front passenger seat, or a spade underneath a dashboard. FIG. 3 shows a state where the sub-battery 2 is set underneath a front passenger seat 13X. Here, the sub-battery 2 can be disposed underneath the driver's seat. Further, the sub-battery 2 can be also disposed underneath the rear seat 13. In the vehicle having plural rows of the seats 13 like a station wagon, a one-box car, or the like, the sub-battery 2 can be disposed underneath the seat 13 of a second row or a third row. However, when the sub-battery is disposed at a rear portion of the vehicle distant from the engine room, as a length of the harness connecting the electrical equipment battery disposed in the engine room is long, preferably the sub-battery is disposed underneath the front side seat 13 of the vehicle.

### (Electrical Equipment Battery 1)

The electrical equipment battery 1 is a lead battery 1A of a rated voltage 12V. The lead battery 1A has the rated voltage 12V by connecting 6 cells in series. The rated voltage of the lead battery 1A can be adjusted by a number of cells connected in series. Therefore, the electrical equipment battery of the lead battery having a rated voltage other than 12V can be used. Further, the electrical equipment battery can have a rated voltage of 24V, 36V, or 48V by connecting the 12 V batteries. Conventional electrical equipment operates by the power source voltage 12V. The vehicle incorporating the electrical equipment battery of 24V to 48V includes electrical equipment which operates at this voltage.

### (Sub-Battery 2)

As shown in FIG. 4, the sub-battery 2 has the plural battery cells 4, and a housing case 3 which stores these plural cells 4. The sub-battery 2 having the plural battery cells 4 has a high output voltage by connecting the plural battery cells 4 in series, and a large capacity by connecting the plural battery cells 4 in parallel. Thus, the output voltage of the sub-battery is adjusted by a number of the battery cells connected in series, and the capacity of the sub-battery is adjusted by a number of the battery cells 4 connected in parallel.

### (Battery Cell 4)

The battery cells 4 are rechargeable secondary batteries. The battery cells 4 as the secondary batteries are charged with power supplied from a generator 64 installed in the vehicle, and stored power is discharged to the vehicle electric load 61. The battery cells 4 of the figures are nickel hydride batteries as the secondary batteries. Moreover, in place of the nickel hydride batteries, all rechargeable batteries including non-aqueous electrolyte batteries of lithium ion batteries, lithium polymer batteries, or the like, or nickel cadmium batteries can be used for the battery cells 4. The electrical equipment battery 1 of the power source voltage 12V is connected in parallel to the sub-battery in which 10 cells of the nickel hydride batteries are connected in series. As the nickel hydride batteries and the nickel cadmium batteries have the power source voltage 1.2V per cell, its voltage is adjusted at the same voltage as the electrical equipment battery 1 by a number of the batteries connected in series. In place of the nickel hydride batteries, the non-aqueous electrolyte batteries of the lithium ion batteries, the lithium polymer batteries, or the like can be used as the battery cells. The lithium ion batteries, or the lithium polymer batteries are fully charged to 4.1V/cell to 4.2V/cell. Therefore, 3 or 4 pieces of the lithium ion batteries, or the lithium polymer batteries are connected in series, and connected in parallel to the electrical equipment battery.

In the battery cell 4, not shown, an electrode assembly in which a positive electrode plate and a negative electrode plate are stacked in an insulating state by a separator, is disposed in an outer case. Then, an electrolyte is filled to a predetermined liquid level, and an opening of the outer case is sealed by a sealing plate. The batter cell 4 has a gas exhaust valve for exhausting a gas generated in the outer case outside. The gas exhaust valve opens when an internal pressure becomes higher than a predetermined pressure by the generated gas, and then it prevents the internal pressure from increasing. The gas exhaust valve has a valve member which closes or seals a gas exhaust opening. The valve member configures a thin film which is broken at a predetermined pressure, a valve which is pressed to a valve seat by a resilient member so as to open at a predetermined pressure. By opening the gas exhaust valve, the inner portion of the battery cell is opened outside through the gas exhaust opening, and by releasing the inner gas, an increase of the inner pressure is prevented.

In the sub-battery 2 of FIG. 4, the battery cell 4 is a cylindrical battery. In the sub-battery 2, ten pieces of the battery cells 4 are connected in series, and are disposed at a horizontal posture in the same plane, and then form an assembled battery 7 as one unit. In the one unit of the assembled battery 7, two pieces of the cylindrical battery cells 4 are arranged in a linear line, and are connected in series, and two pieces of the battery cells 4 connected in series are arranged in five rows. In the battery cells 4 arranged in the five rows, the battery cells 4 in the adjacent rows are arranged in the opposite directions, and these battery cells 4 are connected in series, and then ten pieces of the battery cells 4 are connected in series. In the sub-battery 1 of FIG. 4, two units of the assembled batteries 7 are vertically stacked, and the stacked assembled batteries 7 are connected in parallel to each other. Namely, total twenty pieces of the nickel hydride batteries are connected in ten series and two parallel. As shown in FIG. 4, in the sub-battery 2 in which the plural assembled batteries 7 are stacked and disposed, and are connected in parallel, the current capacity can be increased by increasing a number of the assembled batteries 7 connected in parallel. For example, two of the assembled batteries 7 having the current capacity 5 Ah per unit are stacked, and then the current capacity of the sub-battery 2 becomes 10 Ah which is two times more than that of the one unit.

Here, in the sub-battery 2 in which the plural assembled batteries are vertically stacked and disposed, and are connected in parallel to each other, a vertical length of the housing case 3 becomes big. As the housing case 3 is disposed in a storage space 15 underneath the seat 13, in the case where the vertical length of the housing case 3 is too big, it is difficult to set it in the limited storage space 15 underneath the seat 13. Further, it is difficult to work at the time of wiring or maintenance. Therefore, the structure of the sub-battery 2 is not limited to the structure where the plural assembled batteries 7 are vertically stacked, and the plural assembled batteries 7 are also horizontally arranged and are connected in parallel. In addition, in the sub-battery 2, a plurality of the battery cells 4 are vertically, horizontally arranged so as to store it in a space underneath the seat 13, and the plural assembled batteries can be also connected in parallel.

### (Housing Case 3)

The housing case 3 has a outer shape of a rectangular box. Preferably, the housing case 3 is made of a material having an excellent insulation property, for example, a resin. The housing case 3 of the figures has a shape and a size in which the plural battery cells 4 are stored in a predetermined arrangement. Further, the housing case 3 has a shape and a size which can be disposed in the storage space 15 underneath the seat 13 in the vehicle cabin 12. The housing case 3 has a sealed structure such that the gas exhausted from the stored battery cells 4 does not leak outside the case. In the housing case 3 of the sealed structure, even in a state that the internal pressure of the stored battery cells 4 is increased and the gas is exhausted, the gas filling in the case does not leak outside the case. Therefore, it is effectively prevented that the gas exhausted from the battery cells 4 fills the vehicle cabin 12. However, when the sub-battery has a gas duct or the like of a sealed structure which exhausts the gas exhausted from the battery cells without leaking outside, the housing case does not necessarily need to have a sealed structure. The housing case without a sealed structure is mass-produced at a low cost with a simple structure, and also by opening a ventilating hole through which the air passes, the incorporated battery cells can be effectively cooled.

In order to dispose underneath the seat 13, a longitudinal length and a lateral length of the housing case 3 shown in FIG. 3 and FIG. 4 are smaller than a longitudinal length and a lateral length of the seat 13, and also the vertical length of the housing case 3 is smaller than a distance between a bottom surface 13A of the seat 13 and a floor face 14A as an inner wall 14. For example, the longitudinal length and the lateral length of the housing case 3 are 90% or less, preferably 80% or less of the longitudinal length and the lateral length of the seat 13, and also the vertical length of the housing case 3 is 90% or less, preferably 80% or less of the distance between the bottom surface 13A of the seat 13 and a floor face 14A as the inner wall 14.

In addition, at one side surface as a terminal surface 3A of the housing case 3 shown in the figures, output terminals 19 for charging and discharging are exposed. In the housing case 3 shown in the figures, the positive and negative output terminals 19 project at both sides of the terminal surface 3A. Thus, a structure in which the output terminals 19 are provided on the side surface of the housing case 3, has a feature that the housing case 3 having the restricted vertical length can be disposed in a narrow space underneath the seat 13, and also connections of the output terminals 19 and the harness 6 are easily carried out. As shown in FIG. 4, the output terminals 19 exposed at the terminal surface 3A of the housing case 3 are connected to the harness 6 through connecting terminals 29. Here, in the housing case 3, an upper surface can be a terminal surface. In this case, the harness is connected to the output terminals exposed on the upper surface.

In addition, the housing case, not shown, may have a waveform shape at the peripheral surface along the outer shape of the cylindrical batteries stored inside. By the housing case of this shape, the stored cylindrical batteries can tightly contact the housing case, and also the surface area of the case is increased, compared with a case of a rectangular box shape, and then a cooling performance of the housing case is enhanced.

Further, the housing case 3 has a gas exhaust portion 9 which exhausts the gas exhausted from the stored battery cells 4 outside the housing case 3. In the gas exhaust portion 9 shown in the figures, the one end portion of the gas exhaust portion 9 as a gas exhaust tube portion 31 is coupled to the housing case 3, and the other end portion of the gas exhaust portion 9 as a coupling portion 31A of the gas pipe 8 projects outside the housing case 3. The gas exhaust tube portion 31 is connected to an inside of the housing case 3 with consecutive space, and the gas which fills in the housing case can be exhausted outside through the gas pipe 8 coupled to the coupling portion 31A. The housing case 3 shown in the figures has the gas exhaust tube portion 31 on the upper surface of the case. In this structure, the housing case 3 is stably fixed on the floor face 14A of the vehicle cabin 12, and then the gas pipe 8 can be easily coupled. Here, the housing case may have the gas exhaust tube portion 31 on the side surface. For example, the housing case 3 has the coupling portion on the terminal surface, the harness and the gas pipe which are coupled to the terminal surface are led to the same direction of the housing case 3 and disposed.

### (Fixing Mechanism 5)

A fixing mechanism 5 fixes the housing case 3 at a fixed position underneath the seat 13. The fixing mechanism 5 shown in the figures comprises a coupling member 21 which fixes the housing case 3 on the floor face 14A of the vehicle cabin 12. For example, a metal fitting which is made by bending a metal board can be used as the coupling member 21. The coupling member 21 shown in FIG. 3 and FIG. 4, a belt-shaped metal board is bent in a C-shape, and both end portions thereof are bent outside to make bending board portions. These bending board portions as fixing portions 21B are fixed on the floor face. The coupling member 21 of this shape includes the fixing portions 21B at both end portions thereof which are fixed on the floor face 14A as the inner wall 14 of the vehicle cabin 12, for example, on a chassis 20 of the vehicle, a holding portion 21A which holds the housing case 3 with a center portion of the holding portion 21A projecting upward. The fixing portion 21B is fixed on the chassis 20 by a bolt 22 and a nut 23, or by weld-fixing. In the structure where the coupling member 21 is fixed on the chassis 20 by the bolt 22 and the nut 23, for example, a through hole (not shown in the figures) which the bolt penetrates at a fixed position of the chassis 20, is opened. And the nuts 23 is fixed on the rear side of the chassis 20 facing the through hole by weld-fixing or the like, and by fixing the bolt 22 at the fixed position of the chassis 20, the coupling member 21 can be fixed. In place of this, a screw portion of the bolt projects toward the floor face side and is fixed on the chassis 20, not shown in the figures, and the fixing portion of the coupling member is inserted into the screw portion, and then the coupling member 21 may be fixed. The holding portion 21A is fixed to the housing case 3 by a screw, or can be fixed to the housing case 3 by an engaging structure, or gluing or adhering. Here, the coupling member is not limited to the above shape, and an L-shaped metal fitting or a Z-shaped metal fitting, or many kinds of shapes by combination of these metal fittings can be used. The above fixing structure 5 fixes the housing case 3 of the sub-battery 2 on the floor face 14A of the vehicle cabin 12, and additionally, also the fixing structure of the coupling member can fix the housing case on the bottom surface side of the seat.

Preferably, the housing case 3 is disposed in a posture where the terminal surface 3A having the output terminals 19 faces in the right and left direction of the vehicle. It is a reason why it is prevented that a foreign object or the like which approaches from the front-back direction directly contacts the terminal surface 3A. Here, the sub-battery 2 does not necessarily need that the terminal surface having the output terminals faces in the right and left direction of the vehicle, and may be disposed in a posture where the terminal surface faces in the right and left direction. For example, in the sub-battery, by a covering member which covers the output terminals or the terminal surface, a contact of the foreign object from outside can be prevented. Further, the housing case may have the output terminals on the upper surface.

By the above structure, in the sub-battery 2 disposed in the storing space underneath the seat 13, the output terminals 19 disposed on the terminal surface 3A of the housing case 3 are connected to the harness 6, and the coupling portion 31A of the gas exhaust tube portion 31 provided in the housing case 3 is coupled to the gas pipe 8.

### (Harness 6)

The electrical equipment battery 1 and the sub-battery 2 which are respectively disposed outside and inside the vehicle cabin 12, are connected in parallel through the harness 6. The harness 6 is inserted through a pull-out hole 16 that penetrates the inner wall 14 of the vehicle cabin 12, and electrically connects the sub-battery inside the vehicle cabin 12 to the electrical equipment battery 1 positioned outside the vehicle cabin 12. In the power supply device, a connecting switch can be connected between the electrical equipment battery and the sub-battery. In such a power supply device, the electrical equipment battery and the sub-battery are connected in parallel in the ON state of the connecting switch, and connection between the electrical equipment battery and the sub-battery is cut off in the OFF state of the connecting switch.

In the vehicle shown in FIG. 3 and FIG. 4, the harness 6 coupled to the sub-battery 2 penetrates the inner wall 14 of the vehicle cabin 12, and is led outside the vehicle cabin 12. Generally, the vehicle cabin 12 is separated from outside by the inner wall 14 made of a metal board. Therefore, in the structure where the electrical equipment battery 1 is disposed outside the vehicle cabin 12 and the sub-battery 2 is disposed inside the vehicle cabin 12, it is necessary that the harness 6 connecting the electrical equipment battery 1 and the sub-battery 2 in parallel penetrates the inner wall 14 of the vehicle cabin 12. In the vehicle shown in the figures, the pull-out hole 16 is opened at the inner wall 14 made of the metal board, and the harness 6 is wired through the pull-out hole 16, and then the electrical equipment battery 1 and the sub-battery 2 respectively disposed outside and inside the vehicle cabin 12 are electrically connected. In the vehicle shown in the figures, the pull-out hole 16 is opened at the floor face 14A as the inner wall 14 of the vehicle cabin 12, and the inserted harness 6 penetrates the floor face 14A of the vehicle cabin 12 through the pull-out hole 16, and is led outside.

Here, the pull-out hole 16 does not necessarily need to be opened at the floor face 14A of the vehicle cabin 12. For example, in the rear drive vehicle where a driving shaft for driving rear wheels is disposed at the center of the vehicle, a projecting bank-like shaped portion projecting from the floor face of the vehicle cabin is provided for disposing the driving shaft therein at the center of the vehicle. A pull-out hole can be opened at the side surface of the projecting bank-like shaped portion, and the harness is inserted through this pull-out hole, and is led outside the vehicle cabin.

### (Gas Pipe 8)

The gas pipe 8 is a tube which exhausts a gas exhausted from the battery cells 4 outside the vehicle cabin 12, and is coupled to the gas exhaust portion 9 of the housing case 3. The gas pile 8 is made of a plastic tube, and is preferably flexible and heat resistant. The gas pipe 8 as the plastic tube is inserted through the pull-out hole 16 that penetrates the inner wall 14 of the vehicle cabin 12, and the one end portion of the gas tube 8 is coupled to the coupling portion 31A of the gas exhaust tube portion 31 provided in the housing case 3, and the other end portion is led outside the vehicle cabin 12. Namely, without opening a through hole at the inner wall 14 of the vehicle cabin 12 for exclusive use to lead the gas pipe 8 outside the vehicle cabin 12, the pull-out hole 16 opened at the inner wall 14 of the vehicle cabin 12 to insert the harness 6 through also is used as the pull-out hole for the gas pipe 8, and the gas pipe 8 is inserted through this pull-out hole 16, and is led to outside the vehicle cabin. Thus, the structure where the pull-out hole 16 at which the harness 6 is wired is also used as the pull-out hole of the gas pipe 8, can simplify a manufacturing process since a through hole for exclusive use to insert the gas pipe 8 through is not opened.

Further, the gas pipe 8 which is inserted through this pull-out hole 16 at the inner wall 14 of the vehicle cabin 12, as shown in FIG. 4, is coupled integrally with the harness 6, and is led outside the vehicle cabin 12 with the harness 6. The gas pipe 8 and the harness 6 shown in FIG. 4 are integrally coupled in a state of being covered with a bellows shape of a covering tube 18, and are inserted through the pull-out hole 16 opened at the inner wall 14 of the vehicle cabin 12. The covering tube 18 shown in the figures is formed in the bellows shape using a thin hard plastic, and is flexible. The covering tube 18 is cut at a cutting line 18A longitudinally extending to both ends, and the cutting line 18A is opened, and then the gas pipe 8 and the harness 6 are inserted inside from this opening portion. This structure of the covering tube 18 can simply store and cover the gas pipe 8 and the harness 6. Thus, in the structure where the gas pipe 8 and the harness 6 is piped in the vehicle in the state of being covered with the bellows shape of the covering tube 8, while the harness 6 and the gas pipe 8 are simultaneously, efficiently piped, and the harness 6 and the gas pipe 8 are protected by the covering tube. Further, the covering tube 18 inserted through the pull-out hole 16 of the inner wall 14, not shown in the figures, a space between the periphery of the covering tube 8 and the opening edge of the pull-out hole 16, and a space between the gas pipe 8 and the harness 6 stored in the covering tube 8 and the inner surface of the covering tube 8 are sealed with a packing or a sealing material. As such sealing member, a packing or a cap of urethane or rubber, or a filling material can be used. In this way, the structure where spaces around the pull-out hole 16 or the covering tube 18 are airtightly sealed, surely prevents the air outside the vehicle cabin from intruding inside the vehicle cabin through the pull-out hole 16 or the covering tube 18. This covering tube 18 is piped from the inside of the vehicle cabin 12 to the engine room 11 of the vehicle, or is piped to the middle between the pull-out hole 16 and the engine room 11.

Further, the gas pipe and the harness, not shown in the figures, can be integrally bound by a binding device. As such a binding device, a plastic binding member, a metal wire, or a tape can be used. In the structure where the gas pipe and the harness are integrally coupled by the binding device, in the process of inserting the harness into the pull-out hole, also the gas pipe is simultaneously inserted. Here, the gas pipe and the harness do not necessarily need to be integrally coupled by the binding device.

The harness 6 led out from the pull-out hole 16 provided at the inner wall 14 of the vehicle cabin 12, is wired to the engine room 11, and is connected to the electrical equipment battery 1. The gas pipe 8 led out from the pull-out hole 16 is extended to the engine room 11, and the tip opening thereof is opened in the engine room 11, or without being extended to the engine room 11, the tip opening thereof is opened outside the vehicle cabin.

### (Vehicle Electrical Equipment Auxiliary Battery)

In the above power supply device 100, a vehicle electrical equipment auxiliary battery unit 10 comprises, the sub-battery 2 which stores the plural battery cells 4 in the housing case 3, the fixing mechanism 5 which fixes the housing case 3 of the sub-battery 2 in the vehicle cabin 12 (underneath the seat 13), the harness 6 which connects the sub-battery 2 to the electrical equipment battery 1 positioned outside the vehicle cabin 12 in parallel, and the gas pipe 8 which exhausts the gas exhausted from the battery cells 4 outside the vehicle cabin 12. The vehicle electrical equipment auxiliary battery unit is installed in the vehicle having the electrical equipment battery 1, and the sub-battery 2 is connected to the electrical equipment battery 1. Therefore the vehicle electrical equipment auxiliary battery unit functions as the sub-battery 2 helping the electrical equipment battery 1.

### Embodiment 2

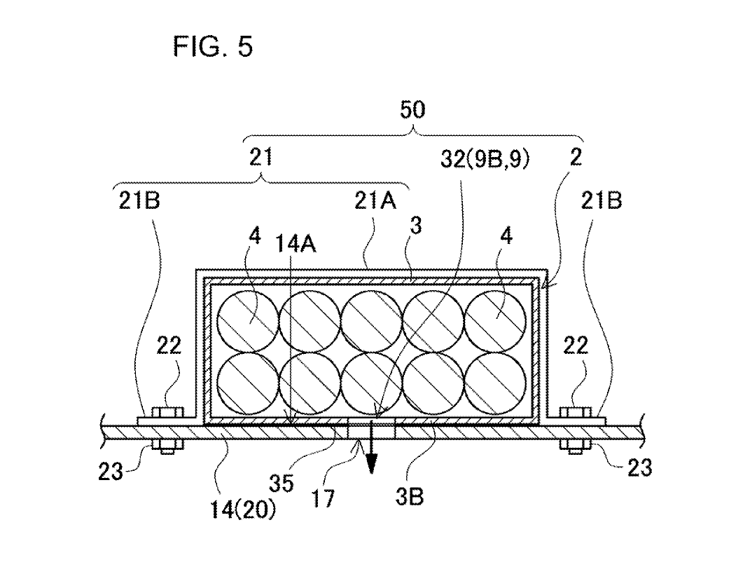

In addition, in the power supply devices shown in FIG. 5 to FIG. 7, the gas exhausted from the battery cells 4 incorporated in the sub-battery 2, directly penetrates the floor face 14A of the vehicle cabin 12 outside the vehicle cabin 12 without using the gas pipe 8. In the power supply devices shown in these figures, the housing case 3 is fixed on the floor face 14A by the fixing mechanism 5, and the housing case 3 has the gas exhaust portion 9 to exhaust the gas filling in the housing case 3 outside the housing case 3. Here, in the power supply device shown in FIG. 5 to FIG. 7, except for the structure where the gas filling in the housing case 3 is exhausted outside the vehicle cabin 12, the structure is the same structure as the power supply device described in the above embodiment 1. Therefore, the same members as in the above explanation are marked with the like reference marks, and the detailed explanation is omitted.

### (Gas Exhaust Portion 9)

The power supply devices shown in FIG. 5 to FIG. 7 have the gas exhaust portion 9 to exhaust the gas filling in the housing case 3 outside the housing case 3. The gas exhaust portion 9 exhausts the gas exhausted from the housing case 3 outside the vehicle cabin 12 such that the gas passes through a through hole 17 opened at the floor face 14A of the vehicle cabin 12.

The gas exhaust portion 9B shown in FIG. 5 is a coupling hole 32 opened at a bottom side facing surface 3B of the housing case 3. The gas exhaust portion 9B as the coupling hole 32 is coupled to the through hole 17 opened at the floor face 14A of the vehicle cabin 12. In this structure, the gas filling in the housing case 3 is exhausted outside the vehicle cabin 12 with the gas passing through from the coupling hole 32 opened at the bottom side facing surface 3B to the through hole 17 opened at the floor face 14A of the vehicle cabin 12. This structure simplifies a structure omitting a long gas pile, or a trouble of piping it, and also the gas exhausted from the battery cells 4 can be exhausted outside the vehicle cabin 12. In the power supply device shown in the figure, a packing 35 having a ring shape along the opening edges of the coupling hole 32 and the through hole 17 is disposed in order to airtightly seal the coupling hole 12 of the housing case 3 and the through hole 17 of the floor face 14a.

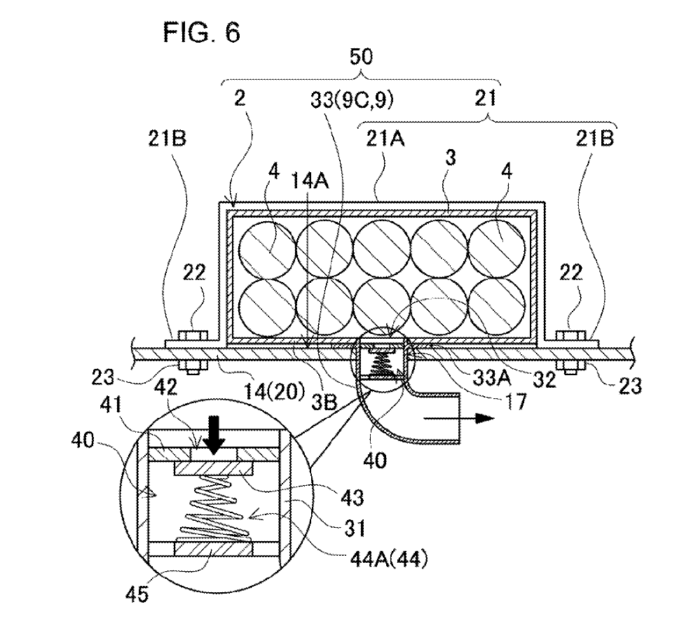

Further, the gas exhaust portion 9C shown in FIG. 6 is a gas exhaust tube portion 33 coupled to the coupling hole 32 opened at the bottom side facing surface 3B. The gas exhaust tube portion 33 is a tube made of a resin or the like, and its one end is airtightly coupled to the coupling hole 32 of the housing case 3, and also its other end passes through the through hole 17 of the floor face 14A and is opened outside. The gas exhaust tube portion 33 is curved in a faucet shape in the whole appearance, and its tip end led outside the vehicle cabin 12 is opened in the horizontal direction. The gas exhaust tube portion 33 shown in the figure has a flange portion 33A at the coupling portion to the housing case 3 in order to be airtightly coupled to the coupling hole 32, and the flange portion 33A tightly contacts the opening edge portion of the coupling hole 32.

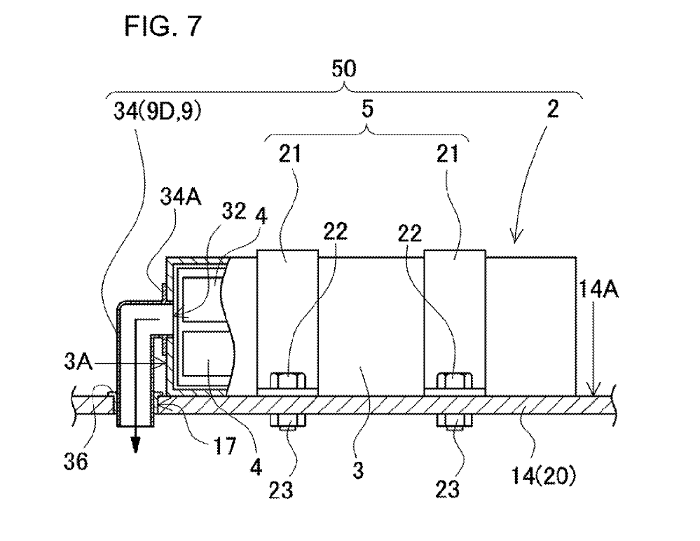

Further, the gas exhaust portion 9D shown in FIG. 7 is a gas exhaust tube portion 34 coupled to the coupling hole 32 opened at the bottom side facing surface 3B. The gas exhaust tube portion 34 is also a tube made of a resin or the like, and its one end is airtightly coupled to the coupling hole 32 of the housing case 3, and also its other end passes through the through hole 17 of the floor face 14A and is opened outside. The upper tip portion of the gas exhaust tube portion 34 in the figure is curved in the horizontal direction, and its lower portion is extended downward, and its low end is led and opened outside the vehicle cabin 12. The gas exhaust tube portion 34 also has a flange portion 34A at the coupling portion to the housing case 3 in order to be airtightly coupled to the coupling hole 32, and the flange portion 33A tightly contacts the opening edge portion of the coupling hole 32. Further, a packing 36 is inserted between the through hole 17 opened at the floor face 14A and the gas exhaust tube portion 34, and then the gas exhaust tube portion 34 is airtightly coupled to the floor face 14A.

In the sub-battery 2 shown in FIG. 6 and FIG. 7, as the gas exhaust tube portion 33, 34 penetrate the floor surface 14A and the gas in the housing case 3 is exhausted outside the vehicle cabin 12, even under the condition where the vehicle receives vertical vibration by driving, the coupling hole 32 of the housing case 3 and the through hole 17 of the floor face 14A are airtightly coupled to each other through the gas exhaust tube portion 33, 34, and then it effectively prevent the gas leak from this portion.

Further, as shown in FIG. 6, the gas exhaust portion 9 can have an exhaust valve 40. In the state where the gas exhausted from the battery cells 4 fills the housing case 3, this exhaust valve 40 opens a valve when the inner pressure in the housing case 3 increases, and the gas in the housing case passes through it, and is exhausted outside. The exhaust valve 40 is a check valve which makes the gas pass from inside of the housing case 3 toward outside of the vehicle cabin 12 by opening the valve, but does not make the gas pass toward the inside from the outside. In the gas exhaust portion 9 shown in FIG. 6, the exhaust valve 40 as the check valve is provided in the gas exhaust tube portion 33. Here, the check valve 40, not shown in the figure, can be provided at the exhaust opening of the housing case shown in FIG. 5. In this way, in the structure where the exhaust valve 40 is provided at the gas exhaust portion 9, while the gas exhausted from the battery cells 4 passes through the gas exhaust portion 9 and is smoothly exhausted outside the vehicle cabin 12, it surely prevents the gas exhausted outside the vehicle cabin 12 from flowing backward into the housing case 3, and then it effectively prevents the foreign object or the moisture of the outside from flowing into the housing case 3.

The exhaust valve 40 shown in a partially enlarged sectional view of the FIG. 6, is provided in the exhaust tube portion 33, and has a valve base 41 which closes the inside of the this exhaust tube portion 33, a valve body 43 which closes a valve hole 42 opened at the valve base 41, a resilient member 44 which presses the valve body 43 toward the valve base 41.

The valve base 41 as a separating wall which closes inside the tube, is provided in the tube 40. In the valve base 41 of the separating wall, the valve hole 42 is opened in order that the gas in the housing case 3 passes through. The valve hole 42 opened at the valve base 41 is closed by the valve body 43. The valve body 43 has a shape along the peripheral edge of the valve hole 42, and has a size which can close the valve hole 42. The valve body 43 is disposed at the gas exhausting side of the valve base 41, and closes the valve hole 42 in a sealing state. The valve body 43 is pressed by the resilient member 44, and closes the valve hole 42. The resilient member 44 shown in the figure is a coil spring 44A, and its one end is fixed to the valve body 43, and also its other end is fixed to the support member 45 which is fixed in the tube. This resilient member 44, an elastic force by which the valve body 43 presses the valve base 41 is specified by a spring constant of the coil spring 44A, a length of the spring, and the distance between the support member 45 and the valve base 41. Further, the coil spring 44A has a conic shape, and this structure reciprocates the valve body 43 in a predetermined direction.

In the above exhaust valve 40, a pressure of opening the valve is specified by the opening area of the valve hole 42 opened in the valve base 41, and the elastic force of the resilient member 44. Preferably, the exhaust valve 40 opens when the pressure in the housing case 3 becomes more than a predetermined pressure, and the exhaust valve 40 closes when the pressure in the housing case 3 becomes less than a predetermined pressure. In the exhaust valve 40, the valve hole 42 is opened such that the valve body 43 is moved in the direction where the valve body 43 is separated from the valve hole 42 as shown in an arrow of FIG. 6 when the pressure in the housing case 3 becomes more than a predetermined pressure, and the gas in the housing case 3 is exhausted. When the gas in the housing case 3 is exhausted and the pressure in the housing case 3 becomes less than a predetermined pressure, the coil spring 44A recovers the original shape, and the valve body 43 closes the valve hole 42, and then prevents the gas from flowing into the housing case 3 from the outside.

Here, the exhaust valve is not limited to the above structure. In the exhaust valve, the resilient member may be a flat spring. In addition, in the exhaust valve, the valve body is a spherical body, and the valve base may be an opening end portion of a cylindrical tube. In this exhaust valve, the spherical body is moved when the pressure in the exhaust duct increases, and the valve is opened. Further, the check valves of all other structures which have been developed or will be developed in the future can be used as the exhaust valve.

### (Vehicle Electrical Equipment Auxiliary Battery)

In the power supply device shown in FIG. 5 to FIG. 7, a vehicle electrical equipment auxiliary battery unit 50 comprises, the sub-battery 2 which stores the plural battery cells 4 in the housing case 3, the fixing mechanism 5 which fixes the housing case 3 of the sub-battery 2 on the floor face 14A in the vehicle cabin 12, and the gas exhaust portion 9 which exhausts the gas exhausted from the battery cells 4 outside the vehicle cabin 12. The vehicle electrical equipment auxiliary battery unit is installed in the vehicle having the electrical equipment battery 1, and the sub-battery 2 is connected to the electrical equipment battery 1. Therefore the vehicle electrical equipment auxiliary battery unit functions as the sub-battery 2 helping the electrical equipment battery 1.

In the power supply device, the electrical equipment battery 1 and the sub-battery 2 are charged through the generator 64 installed in the vehicle. Further, in the power supply device 100, the electrical equipment battery 1 and the sub-battery 2 are discharged, and power is supplied to the vehicle electric load 61 installed in the vehicle of a starter motor 63, an electrical equipment 62, or the like.

### INDUSTRIAL APPLICABILITY

In the present invention, in a vehicle electrical equipment auxiliary battery, a vehicle power supply device, and a vehicle incorporating the vehicle power supply device, the sub-battery which is connected to the electrical equipment battery 1 can be installed in an ideal state, and appropriately is installed as the vehicle power supply device.

### REFERENCE MARKS IN THE DRAWINGS

100: power supply device
1: electrical equipment battery
1A: lead battery
2: sub-battery
3: housing case
3A: terminal surface
3B: bottom side facing surface
4: battery cell
5: fixing mechanism
6: harness
7: assembled battery
8: gas pipe
9: gas exhaust portion
9A: gas exhaust portion
9B: gas exhaust portion
9C: gas exhaust portion
9D: gas exhaust portion
10: vehicle electrical equipment auxiliary battery unit
11: engine room
12: vehicle cabin
13: seat
13X: front passenger seat
13A: bottom surface
14: inner wall
14A: floor face
15: storage space
16: pull-out hole
17: through hole 17
18: covering tube
18A: cutting line
19: output terminal
20: chassis
21: coupling member
21A: holding portion
21B: fixing portion
22: screw
23: nut
29: connecting terminal
31: gas exhaust tube portion
31A: coupling portion
32: coupling hole
33: gas exhaust tube portion
33A: flange portion
34: gas exhaust tube portion
34A: flange portion
35: packing
36: packing
40: exhaust valve
41: valve base
42: valve hole
43: valve body
44: resilient member
44A: coil spring
45: support member
50: vehicle electrical equipment auxiliary battery unit
61: vehicle electric load
62: electrical equipment
63: starter motor
64: generator

1. A vehicle electrical equipment auxiliary battery unit to being capable of being connected in parallel to an electrical equipment battery installed in a vehicle, comprising:
a sub-battery which stores plural battery cells in a housing case;
a fixing mechanism which fixes the housing case of the sub-battery in a vehicle cabin;
a harness which is inserted through a pull-out hole that penetrates an inner wall of the vehicle cabin, and connects the sub-battery to the electrical equipment battery positioned outside the vehicle cabin in parallel; and
a gas pipe which is coupled to the housing case, and exhausts a gas exhausted from the battery cells outside the vehicle cabin,
wherein the gas pipe is inserted through the pull-out hole, through which the harness is inserted, and is led outside the vehicle cabin.

2. A vehicle electrical equipment auxiliary battery unit to being capable of being connected in parallel to an electrical equipment battery installed in a vehicle, comprising:
a sub-battery which stores plural battery cells in a housing case;
a fixing mechanism which fixes the housing case of the sub-battery to a floor face in a vehicle cabin; and
a gas exhaust portion which exhausts a gas exhausted from the battery cells outside the housing case,
wherein the gas exhaust portion exhausts the gas exhausted from the housing case through a through hole opened at the floor face of the vehicle cabin outside the vehicle cabin.

3. The vehicle electrical equipment auxiliary battery unit according to claim 2,
wherein the gas exhaust portion is a coupling hole opened at a bottom side facing surface of the housing case, and the coupling hole is coupled to the through hole opened at the floor face of the vehicle cabin.

4. The vehicle electrical equipment auxiliary battery unit according to claim 2,
wherein the gas exhaust portion is a gas exhaust tube portion which penetrates the through hole opened at the floor face of the vehicle cabin, and connects an inside of the housing case and an outside of the vehicle cabin with consecutive space.

5. The vehicle electrical equipment auxiliary battery unit according to claim 2,
wherein the gas exhaust portion has an exhaust valve, and the exhaust valve makes the gas pass toward outside of the vehicle cabin, but does not make the gas pass toward the inside of the housing case from the outside of the vehicle cabin.

6. The vehicle electrical equipment auxiliary battery unit according to claim 1,
wherein the battery cells are nickel hydride batteries.

7. The vehicle electrical equipment auxiliary battery unit according to claim 2,
wherein the battery cells are nickel hydride batteries.

8. (canceled)

9. (canceled)

10. A vehicle incorporating a vehicle power supply device comprising:
an electrical equipment battery which supplies power to a vehicle electric load; and
a sub-battery which is connected in parallel to the electrical equipment battery,
wherein the sub-battery is disposed inside a vehicle cabin, and stores plural battery cells in a housing case, and the electrical equipment battery is disposed outside the vehicle cabin,
wherein the housing case is fixed to a floor face in a vehicle cabin, and has a gas exhaust portion which exhausts a gas exhausted from the battery cells outside the housing case, and the gas exhaust portion is coupled to a through hole opened at the floor face, and connects an inside of the housing case and an outside of the vehicle cabin with consecutive space.
